(19) United States
(12) Patent Application Publication
(10) Pub. No.: US 2009/0259485 A1
(43) Pub. Date: Oct. 15, 2009

(54) METHOD AND SYSTEM FOR THE CONTROL OF PERSONAL IDENTITIES IN VIRTUAL NETWORKED ENVIRONMENTS

(75) Inventors: Jamie Perlman, San Francisco, CA (US); Rex O. Ishibashi, Mil Valley, CA (US)

Correspondence Address: PERKINS COIE LLP, P.O. BOX 1208, SEATTLE, WA, 98111-1208, US

(73) Assignee: Originator Media, Inc., Mill Valley, CA (US)

(21) Appl. No.: 12/422,009

(22) Filed: Apr. 10, 2009

Related U.S. Application Data
(60) Provisional application No. 61/043,812, filed on Apr. 10, 2008.

(51) Int. Cl. G06Q 10/00

(52) U.S. Cl. 705/1

(57) ABSTRACT

Methods and systems to allow individuals participating in social networks to establish pseudonymity amongst people they know in real life or in a virtual context are disclosed. In one embodiment, the present invention provides the assignment of disposable aliases or other temporary forms of personal identity, such as an image, to users in a virtual network to obfuscate their real identities or persistent online identities. Another paradigm introduces the notion of a private group or “campfire” where invited users (whether initiated by an individual or systematically broadcast to a broad or limited group) are allowed or expected to use such dynamic aliases to facilitate protected online interaction, expression, and discourse with the group at large (campfire), rather than as multiple one-to-one conversations (hub and spoke).

### CLAIM OF PRIORITY AND CROSS-REFERENCE TO RELATED APPLICATIONS

This application claims priority to U.S. Provisional Patent Application No. 61/043,812, entitled METHOD FOR THE CONTROL OF PERSONAL IDENTITIES IN VIRTUAL NETWORKED ENVIRONMENTS, filed Apr. 10, 2008, which is hereby incorporated by reference in its entirety.

### FIELD OF THE INVENTION

The present invention relates to the management and control of personal identities in networked environments, and more specifically to a method for allowing individuals participating in social networks and other virtual environments to selectively assume an obfuscated identity through a temporary or disposable user alias or other temporary form of personal identity (e.g. an image).

### BACKGROUND

Social networks and other virtual environments enabled by the Internet are largely centered on persistent personal identities. Users' real world names are often used as identifiers, personal photographs are displayed, and online personas are otherwise closely connected to our real selves. Even when users represent themselves using a pseudonym, these identities are persistent within the networks in which they exist (e.g. Tila Tequila on MySpace.com) and can often be tied back to real identities. As a result, the behavior of users within social networks—especially when interacting with people whom they know in the real world, and/or around sensitive and personal topics—can be inhibited, deliberate, and superficial, if not to some degree disingenuous.

The most honest interactions, however, often occur in virtual environments where users can maintain their anonymity. By and large, these communications occur between complete strangers using pseudonyms and, as a result, the communication is largely unfettered. However, this type of anonymous communication between strangers is ultimately fertile ground for deception, lying, and other illicit activities. Deeper personal engagement, including the revelation of one's true identity, is rarely, if ever, achieved.

The safe virtual distance that is generally maintained when complete strangers interact online also affects our engagement with people who are closer to us but still distanced by more than one degree of separation (e.g. friends of our friends and beyond). The benefits of sharing common space as in the real world and the presence of a common personal connection are absent. For example, it is possible for one to interact directly with his friend's friends at a dinner party, and thereby getting to know them and perhaps even achieving a first degree connection with one or more of them. Online, however, despite the fact that one talks of interacting as part of a social “network”, in fact, the interaction that occurs is on a one-to-one basis with many individuals rather than interacting in an online version of the group setting described above (i.e. the dinner party). This method of interaction is more akin to a hub-and-spoke paradigm, centered around a given user (the hub), who generally interacts directly with a multitude of direct connections (the spokes). In such a paradigm, rarely if ever is a group interaction achieved that facilitates a safer, mediated introduction to friends of friends who may well be people with whom a first degree connection is mutually desired.

What is needed is a method and system whereby dynamic groups can be created, analogous to those we create in the real world (e.g., attending a dinner party, sitting around a campfire, etc.). In such a setting, users can feel free to openly engage with second degree connections and beyond and feel comfortable that their ability to gracefully disengage is maintained. At the same time, being able to directly tie a user's disposable identity back to their persistent or real identity allows users to choose to have the virtual connections they make persist, just as friends of friends may choose to do in the real world.

### SUMMARY

In at least one embodiment, the present invention contemplates a variety of methods and systems for the assignment and management of temporary personal identities or disposable aliases in social networks and other virtual environments. The ability to temporarily assume an unknown but unique identity, like wearing a distinct mask at a masquerade party, will allow for more unqualified and honest virtual interactions. That such temporary identities may be used as infrequently as desired (e.g. associated with only one comment made within an virtual environment), or only within a certain context (e.g. while interacting with a specific group of participants or around a specific topic), makes it difficult to tie a collection of statements, opinions, and expressions back to a single identity or individual.

Accordingly, in at least one embodiment, the present invention provides the use of a platform that enables a user to assume a dynamic alias prior to logging into one of a listed number of social networking environments offered through the platform. In one embodiment, the invention also contemplates that an individual user may have multiple dynamic aliases they use in specific contexts (e.g., in different online discussion groups within the same social network environment) and that a user can willingly remove his dynamic alias, and reveal his real or persistent identity to one or more users at any time.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 shows an example of a network based system in which the technique introduced here can be implemented;

FIG. 2A is a graphical representation of communication between relational connections in a typical social network or other virtual environment (hub and spoke paradigm);

FIG. 2B is a graphical representation of dynamic communication between relational connections enabled by the use of dynamic aliases (campfire paradigm);

FIG. 3 is a flow chart showing how users choose to participate in a virtual group using a dynamic alias;

FIG. 4 is a flow chart showing how users participating in a virtual group can mutually agree to interact privately and separate from the larger group; and

FIG. 5 is a flow chart showing how users participating in a virtual group can mutually agree to reveal their persistent and/or real identities.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

In at least one embodiment, the present invention provides methods and systems to allow individuals participating in social networks and other virtual environments (hereinafter “virtual networks”) to establish pseudonymity amongst people they know in real life or in a virtual context, and to specifically break the connection between their behaviors, interests, attitudes, and opinions from their persistent online identities or real selves. At least some of these methods are a result of new paradigms contemplated by the present invention. One paradigm involves the assignment of temporary or disposable aliases or other temporary forms of personal identity, such as an image, (hereinafter “dynamic alias(es)”) to users in a virtual network to obfuscate their real identities or persistent online identities. Another paradigm introduces the notion of a private group or “campfire” where invited users (whether initiated by an individual or systematically broadcast to a broad or limited group) are allowed or expected to use such dynamic aliases to facilitate protected online interaction, expression, and discourse with the group at large (i.e. campfire), rather than as multiple one-to-one conversations (i.e. hub and spokes).

The term “virtual network,” as described herein, refers to any online group of users interacting around a common user platform that facilitates some combination of communication, socialization, and entertainment, and which may or may not require a persistent user identity or the revealing of a user's real name and/or identity. The virtual network contemplated by the present invention can be a closed network, a wide area network, a local area network, a destination website on the World Wide Web, or the Internet itself.

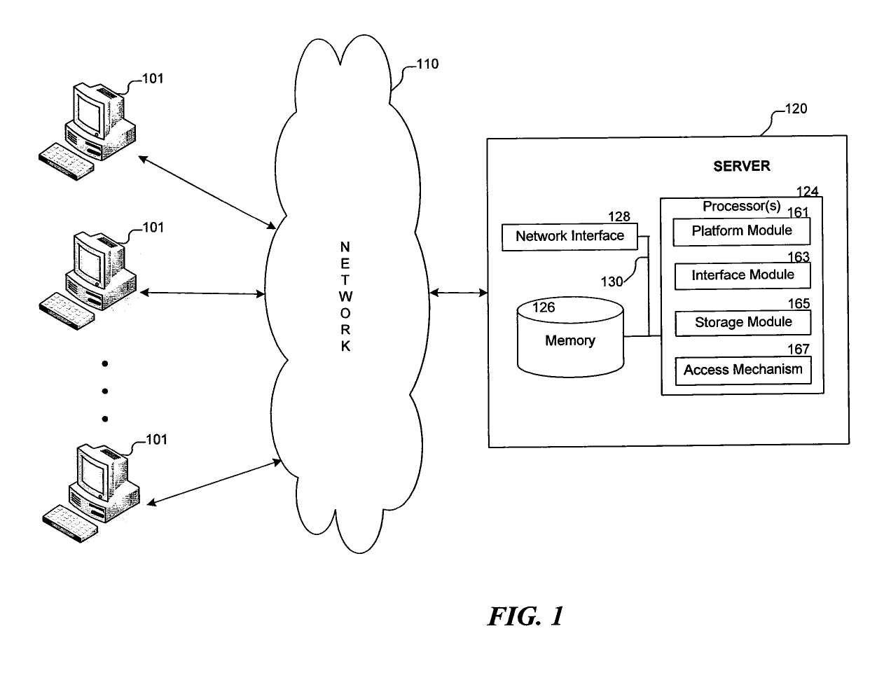

Refer now to FIG. 1, which shows an example of a network based system in which the technique introduced here can be implemented. In FIG. 1, a server 120 is connected to a network 110. In one embodiment, the server 120 is configured to provide various platform related functions of the technique described herein. Also connected to the network 110 is/are one or more clients 101. The clients 101 represent, for example, personal computers associated with users of the system. The users use the clients 101 to access the services hosted or provided by the server 120. The network 110 may be, for example, a local area network (LAN), wide area network (WAN), metropolitan area network (MAN), global area network such as the Internet, a Fibre Channel fabric, or any combination of such interconnects. Each of the clients 101 may be, for example, a conventional personal computer (PC), server-class computer, workstation, handheld computing/communication device, or the like.

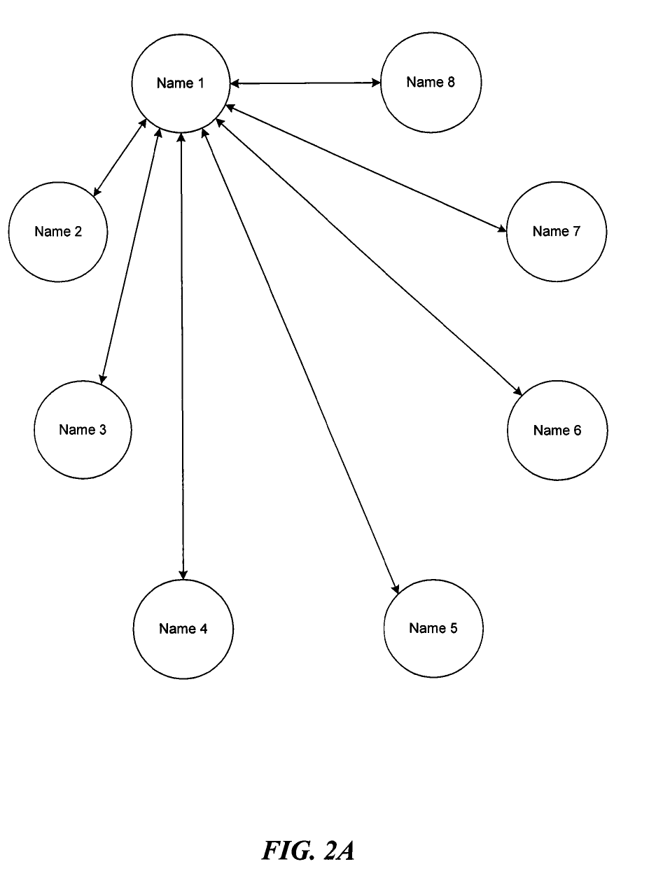

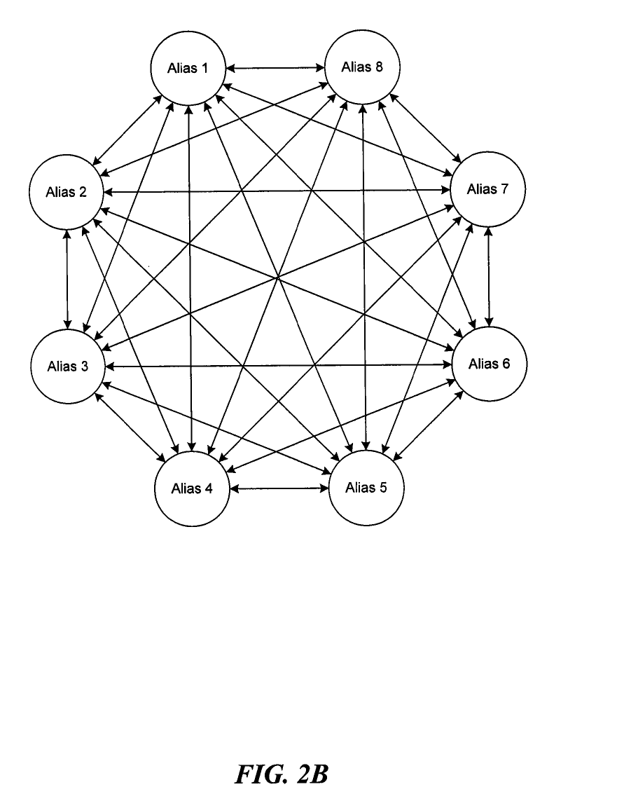

The server 120 includes one or more processors 124 and memory 128 coupled to an interconnect 130. The interconnect shown in FIG. 2 is an abstraction that represents any one or more separate physical buses, point-to-point connections, or both, connected by appropriate bridges, adapters, or controllers. The interconnect 203, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 124 is/are the central processing unit (CPU) of the server 120 and, thus, control the overall operation of the server 102. In certain embodiments, the processor(s) 124 accomplish this by executing software or firmware stored in memory 126. The processor(s) 124 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 126 is or includes the main memory of the server 120. The memory 126 represents any form of random access memory (RAM), read-only memory (ROM), flash memory, or the like, or a combination of such devices. In use, the memory 126 may contain, among other things, code embodying the platform module 161, the interface module 163, the storage module 165, and the access mechanism 167.

In one embodiment, the processor(s) 124 include multiple units/blocks configured to perform various functions of the server 120. The units include a platform module 161, an interface module 163, a storage module 165, and an access mechanism 167, each of which is discussed below. It is noted that these units are described here for illustration of an example, and that the techniques described herein may be performed using other means as understood by people of ordinary skill in the art. In some instances, these units may be located outside of the processor(s) 124. In such instances, the units can be implemented by using programmable circuitry programmed by software and/or firmware, or by using special-purpose hardwired circuitry, or by using a combination of such embodiments.

In one embodiment, the platform module 161 provides a platform through which the server 120 provides dynamic aliasing features to various users accessing the server through the clients 101. In some instances, the platform module provides to the users access to a list of social networking sites. The social networking sites include commercial online social networks (e.g., MySpace®, Facebook®, etc.) or one or more private social networks hosted, for example, by the server 120. The interface module 163, in some embodiments, is configured to enable the user to assume a dynamic alias before the user, for example, logs in to one of the social networking sites.

The dynamic alias is designed to hide a true identity of the user when the user engages in interaction in the social networking sites. A “true identity,” as defined herein, refers to an identity (such as a profile name or user name) assumed by the user during normal interaction in the social networking site. The true identity, for example, reveals a personal trait of the user (e.g., the user's name, or location, or any such indicator identifying the user).

The user may select the dynamic alias from a list of aliases offered by, for example, the interface module. In some instances, the user may create a new alias. A storage module 165 of the server 120 saves a correlation of the user's true identity and the dynamic tag chosen by the user in the storage memory 126 of the server 120 (e.g., for later recovery when a user decides to discard the dynamic disguise and reveal the user's true identity). Finally, in some instances, an access mechanism 167 included in the server 120 enables the user to adopt the dynamic alias and login to a specific online social network using the adopted alias. In some instances, the access mechanism 167 retrieves the user's true identity by, for example, communicating with the storage module 165 when the user decides to reveal a true identity.

FIG. 2A is a graphical representation of communication between relational connections in a typical virtual network. A user, in this case Name 1, is connected to a number of online users who he knows personally or virtually. Even to those whom he knows only virtually, his identity of Name 1 is persistent and is the center of his online persona. In most controlled social networks such as MySpace® or Facebook®D, outward communication by Name 1 is at least somewhat limited systematically and by user protocol to his direct connections (i.e. one degree of separation). Inbound communications to Name 1 are similarly limited to his direct connections, in this case, to Names 2-8.

FIG. 2B is a graphical representation of dynamic communication between relational connections enabled by the use of dynamic aliases. Because real or persistent virtual identities are protected behind the anonymity afforded by dynamic aliases, communication flows dynamically and directly between and among various users who may or may not be first degree connections. For example, Alias 1 can present a topic to be discussed between himself and all of his connections, with or without his participation as intermediary. This communication can be honest, unfettered, and safe, given the obfuscation of identities afforded by the use of dynamic aliases. Communications from any participant in the dynamic group can be broadcast to all seven other participants of the group, or limited to one or more of the participants, who are now identified via their dynamic aliases The interactions have consistent relational context (e.g., Alias 3 made the first and last comment), rather than being completely anonymous and unattributed. At the same time, they are in fact anonymous and allow for complete disengagement among users at the dissolution of the group. The establishment of an alias can occur both in virtual networks where users have an established and persistent identity, or even where no public identity may otherwise exist or be required.

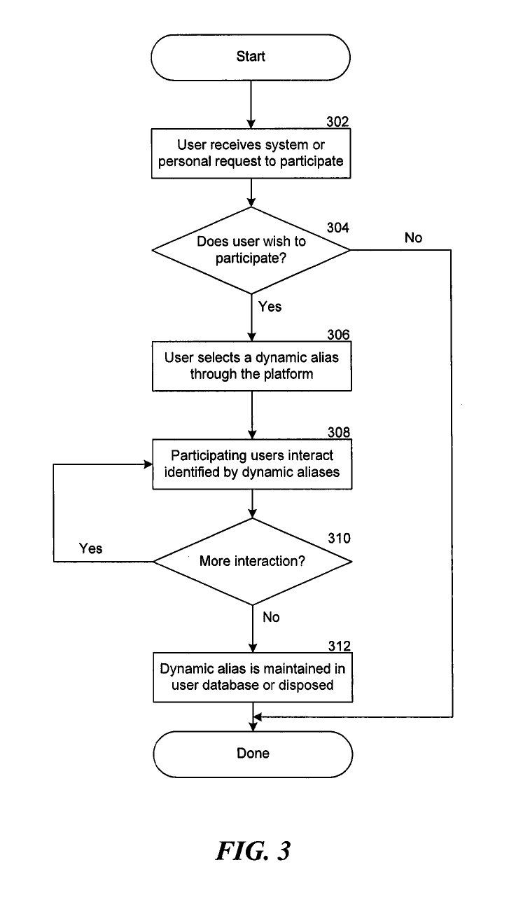

FIG. 3 is a flow chart depicting how users can choose to participate in a virtual group offered through the platform of the server using a dynamic alias. The invitation can be initiated by a single user to all or some subset of his relational connections or can be systematically initiated (e.g., to a group of otherwise un-connected users who have agreed to participate in an online discussion around specific topics or themes). The invitation is the start of a “campfire”, a discussion within a smaller subset of the larger virtual network. The flow begins with the invitation 302, and specifically notes the process by which a user selects a dynamic alias for use within the campfire. The process verifies whether the user wishes to participate in the interaction 304. The alias may then be randomly generated or specified by the participant 306 using the platform module, and facilitates pseudonymity 308 within the context of the specific campfire. In some instances, the process continues until there is continuous interaction between the users 310. Subsequent to completion of the interaction, the dynamic alias may be maintained in the storage module of the server or may be disposed. The invitation can be “closed” (i.e., limited specifically to those who have been invited by the initiator of the campfire), or it may also be “open” and allow for recipients of the original invitation to also invite a limited, or even unlimited number of additional participants to join the campfire.

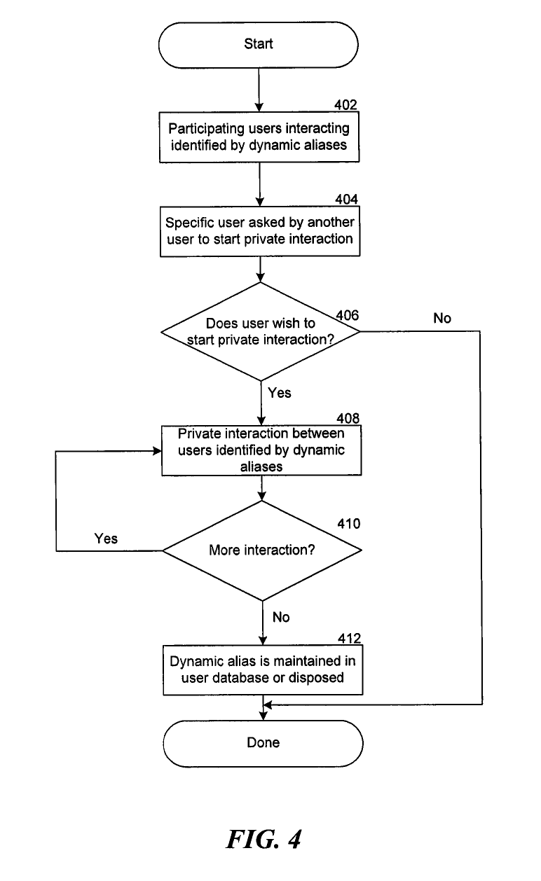

FIG. 4 is a flow chart depicting how users participating in a virtual group can mutually agree to interact privately, and separate from the larger group. Through the ability to tie certain views, opinions, and beliefs to a dynamic alias (e.g., Alias 7 made comments X, Y, and Z), users can “recognize” other users as specific individuals, and therefore, also recognize their desire to connect with them individually. This of course occurs within a system that allows for all users to maintain their anonymity until the point at which some or all such users no longer wish to. Comments directed at individuals can be made on a one-off basis, or result in what is effectively a new campfire being formed around a subset of the original campfire's participants. This activity may even result in additional participants being invited to participate in this new campfire.

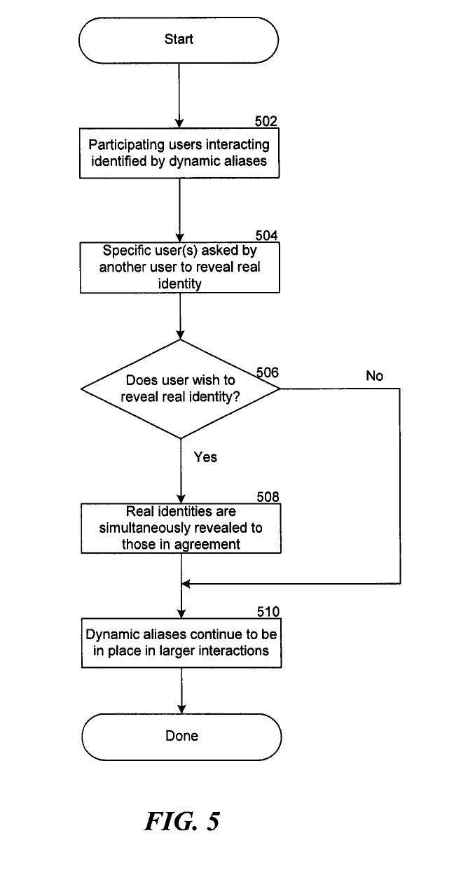

The process illustrated in FIG. 5 starts at 402, where the process maintains the platform enabling a number of users to interact based on their adopted dynamic aliases. At 404, a specific user may be asked by another user to commence a private interaction. At 406, the process verifies whether the user agrees to initiate the private conversation. If at 406 the user indicates that he would like to engage in a private conversation, the process proceeds to 408, where the platform enables a private conversation between the users. It is noted that the user may use a private network offered by the platform to enable the campfire interaction, or the user may utilize a feature offered by one of the commercial social networks. At 410, the process enables the users to interact in the campfire setting. Finally, at 412, the dynamic alias of the users is either maintained in the storage memory associated with the platform, or is disposed as indicated by the user.

FIG. 5 is a flow chart depicting how users participating in a virtual group can mutually agree to reveal their persistent and/or real identities. At 502, the platform, for example, enables participating users to interact using their dynamic aliases within a social network. At 504 and 506, based on the interactions that take place within a campfire, one or more participants may choose to remove their dynamic aliases and reveal their real or persistent online identities. This revelation might be initiated and consummated by a single user (e.g. Alias 6 has revealed herself as Name 6), or might only be facilitated by mutual agreement amongst two or more of the participants. Based on the type of revelation, the real identities are simultaneously revealed to those in agreement, as indicated at 508. However, in some instances, even if the true identities of the users are revealed to the users, the dynamic aliases continue to be in place in larger interactions, as indicated at 510.

Other key dimensions to this primary paradigm is that an individual user can have more than one alias used in different contexts of a single virtual network (e.g. separate discussion groups occurring between different friend subgroups of Name 3). In this way, Name 3 will not always represent himself as Alias 3 and ultimately build a more persistent user profile that can increase the chance of being identified as Name 3. The dynamic aliases can be one-time usable or re-usable by an individual. They may be defined as forever unique to an individual or usable by a multitude of people. They may also be usable in a broad context (e.g. usable across a number of social networks) or only usable in a defined context (e.g. within a specific social network, in a specific online discussion thread, or in the context of an online game or game session).

The techniques introduced above can be implemented by using programmable circuitry programmed by software and/or firmware, or by using special-purpose hardwired circuitry, or by using a combination of such embodiments. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method of controlling personal identities of participants in online networking environments, the method comprising:
providing a platform for a plurality of users to initiate an online social networking activity, the platform providing access to each of the plurality of users to one or more online social networks;
providing, to a first user of the platform, an interface to enable the first user to select a first dynamic alias prior to logging in to a specific online social network, wherein the dynamic alias hides a true identity of the first user associated with the specific online social network;
retaining, by the platform, a correlation between the true identity of the first user and the first dynamic alias of the first user; and
providing, by the platform, access to the first user to the specific online social network, wherein the platform enables the first user to utilize the first dynamic alias to interact with other users of the specific online social network, and wherein the true identity of the first user is hidden from other users of the specific online social network.

2. The method of controlling personal identities of participants in online networking environments as recited in claim 1, wherein the one or more online social networks includes a private network operated by the platform.

3. The method of controlling personal identities of participants in online networking environments as recited in claim 1, wherein the one or more online social networks includes a commercial online social network.

4. The method of controlling personal identities of participants in online networking environments as recited in claim 1, wherein the platform presents a list of social networks for the first user to choose from, enabling the first user to log in to a particular social network and present the first dynamic alias as the first user's identity within the particular social network.

5. The method of controlling personal identities of participants in online networking environments as recited in claim 4, wherein the first user uses a specific dynamic alias to login to a first social network of the list of social network, further wherein the platform retains an association between the first user's specific dynamic alias and the first social network, enabling the first user to reuse the specific dynamic alias to login to the first social network during a subsequent session.

6. The method of controlling personal identities of participants in online networking environments as recited in claim 4, wherein the first user uses a specific dynamic alias to login to any social network of the list of social networks, further wherein the platform retains an association between the first user and the specific dynamic alias, enabling the first user to reuse the specific dynamic alias to login to any social network during a subsequent session.

7. The method of controlling personal identities of participants in online networking environments as recited in claim 4, wherein the first user uses a new dynamic alias for each new session to login to a given social network.

8. The method of controlling personal identities of participants in online networking environments as recited in claim 1, wherein the platform enables the first user to initiate an event to invite a second user to use a second dynamic alias to login to a specific social network.

9. The method of controlling personal identities of participants in online networking environments as recited in claim 1, wherein the platform enables the first user to initiate an event to invite a plurality of users to a campfire setting, wherein, in the campfire setting, each invited user utilizes a distinct dynamic alias to partake in an interaction with remaining users in the campfire setting.

10. The method of controlling personal identities of participants in online networking environments as recited in claim 9, wherein each user in the campfire setting is provided the capability to initiate direct first-degree interactions with any remaining user in the campfire setting.

11. The method of controlling personal identities of participants in online networking environments as recited in claim 9, wherein, subsequent to the first user logging into a specific online social networking environment, the platform enables the first user to reveal the first user's true identity to remaining users of the campfire setting.

12. The method of controlling personal identities of participants in online networking environments as recited in claim 11, wherein, the first user reveals the first user's true identity in a unilateral action, whereby the true identity of the first user is revealed to remaining users of the campfire setting, but true identities of the remaining users are not revealed to the first user.

13. The method of controlling personal identities of participants in online networking environments as recited in claim 11, wherein, the first user reveals the first user's true identity based on a mutual understanding with a second user in the campfire setting, whereby the true identity of the first user is revealed to the second user and the true identity of the second user is revealed to the first user, but the true identities of the first and the second users remain hidden to any remaining users in the campfire setting.

14. The method of controlling personal identities of participants in online networking environments as recited in claim 11, wherein, the platform enables the first user to revoke a revealed true identity and assume one of:
a new dynamic alias; or
a previously used dynamic alias.

15. A method for controlling personal identities of participants in online social networking environments, the method comprising:
establishing a platform for linking a first user to a plurality of online social networking environments;
providing, through the platform, an option for the first user to adopt a dynamic alias prior to the first user logging into a first online social networking environment;
replacing a true identity of the first user with an adopted alias subsequent to the user selecting the adopted alias from the platform;
storing a correlation of the true identity of the first user to the adopted alias in a storage memory accessible to the platform; and
providing an access mechanism to enable the first user to login to the first online social networking environment using the adopted alias.

16. The method for controlling personal identities of participants in online social networking environments as recited in claim 15, wherein the access mechanism of the platform enables the first user to initiate an event to invite a second user to use a second dynamic alias to login to the first online social networking environment.

17. The method for controlling personal identities of participants in online social networking environments as recited in claim 15, wherein the access mechanism of the platform enables the first user to initiate an event to invite a plurality of users to a campfire setting, wherein, in the campfire setting, each invited user utilizes a distinct dynamic alias to partake in an interaction with remaining users in the campfire setting.

18. The method for controlling personal identities of participants in online social networking environments as recited in claim 17, wherein campfire setting is initiated within the first online social networking environment.

19. The method for controlling personal identities of participants in online social networking environments as recited in claim 17, wherein campfire setting is initiated in a private social networking environment associated with the platform.

20. The method of controlling personal identities of participants in online networking environments as recited in claim 15, wherein, subsequent to the first user logging into the first online social networking environment, the access mechanism of the platform enables the first user to reveal the first user's true identity to defined users of the first online social networking environment.

21. The method of controlling personal identities of participants in online networking environments as recited in claim 20, wherein, the defined users includes any remaining users of the first online social networking environment.

22. The method of controlling personal identities of participants in online networking environments as recited in claim 20, wherein, the defined users includes one or more specific users identified by the first user.

23. A system for controlling personal identities of participants in online networking environments, the system comprising:
a platform module to provide a platform for a plurality of users to engage in an online social networking activity, the platform module providing access to each of the plurality of users to one or more online social networks;
an interface module to provide, to a first user, an interface to enable the first user to select a first dynamic alias prior to logging in to a specific online social network, wherein the dynamic alias hides a true identity of the first user associated with the specific online social network;
a storage module to retain a correlation between the true identity of the first user and the first dynamic alias of the first user; and
wherein, the platform module provides access to the first user to the specific online social network, and enables the first user to utilize the first dynamic alias to interact with other users of the specific online social network, and wherein the true identity of the first user is hidden from the other users of the specific online social network.

24. The system for controlling personal identities of participants in online networking environments as recited in claim 23, the platform module presents a list of social networks for the first user to choose from, enabling the first user to log in to a particular social network and present the first dynamic alias as the first user's identity within the particular social network.

25. The system for controlling personal identities of participants in online networking environments as recited in claim 24, wherein the first user uses a specific dynamic alias to login to a first social network of the list of social network, further wherein the storage module retains an association between the first user's specific dynamic alias and the first social network, enabling the first user to reuse the specific dynamic alias to login to the first social network during a subsequent session.

26. The system for controlling personal identities of participants in online networking environments as recited in claim 24, wherein the first user uses a specific dynamic alias to login to any social network of the list of social networks, further wherein the storage module retains an association between the first user and the specific dynamic alias, enabling the first user to reuse the specific dynamic alias to login to any social network during a subsequent session.

27. The system for controlling personal identities of participants in online networking environments as recited in claim 24, wherein the first user uses a new dynamic alias for each new session to login to a given social network.

28. The system for controlling personal identities of participants in online networking environments as recited in claim 23, wherein the platform enables the first user to initiate an event to invite a second user to use a second dynamic alias to login to a specific online social network.

29. The system for controlling personal identities of participants in online networking environments as recited in claim 23, wherein the platform enables the first user to initiate an event to invite a plurality of users to a campfire setting, wherein, in the campfire setting, each invited user utilizes a distinct dynamic alias to partake in an interaction with remaining users in the campfire setting.

30. The system for controlling personal identities of participants in online networking environments as recited in claim 29, wherein each user in the campfire setting is provided the capability to initiate direct first-degree interactions with any remaining user in the campfire setting.

31. A system for controlling personal identities of participants in online social networking environments, the system comprising:
a processor; and
a memory storing code which, when executed by the processor, causes the system to perform a process, the process including:
establishing a platform for linking a first user to a plurality of online social networking environments;
providing, through the platform, an option for the first user to adopt a dynamic alias prior to logging the user into a first online social networking environment;
replacing a true identity of the first user with an adopted alias subsequent to the user selecting the adopted alias from the platform;
storing a correlation of the true identity of the first user to the adopted alias in a storage memory accessible to the platform; and
providing an access mechanism to enable the first user to login to the first online social networking environment using the adopted alias.
